(19) United States
(12) Patent Application Publication
(10) Pub. No.: US 2026/0312399 A1
(43) Pub. Date: Oct. 8, 2026

(54) COMMUNICATION DEVICE AND COMMUNICATION SYSTEM

(71) Applicant: DENSO CORPORATION, Kariya-city (JP)

(72) Inventors: Sho MATSUMOTO, Kariya-shi (JP); Tomohisa KISHIGAMI, Kariya-shi (JP)

(21) Appl. No.: 19/546,981

(22) Filed: Feb. 23, 2026

(30) Foreign Application Priority Data
Apr. 2, 2025 (JP) 2025-061463

(51) Int. Cl. H02H 9/04; H04L 12/40; H04L 25/08

(52) U.S. Cl. CPC H02H 9/04; H04L 12/40032; H04L 25/085; H04L 2012/40215; H04L 2012/40273

(57) ABSTRACT

A communication device is provided that includes an electrostatic discharge protection circuit that can prevent interference with high-speed communication. A communication device has an electrostatic discharge protection circuit arranged between connection lines, which connect a communication bus and a transceiver, and a ground potential. The electrostatic discharge protection circuit is provided on the connection line and includes two Zener diodes connected in reverse, which become conductive when a voltage equal to or greater than a predetermined value is applied, and a capacitor connected in series with the two Zener diodes.

### CROSS REFERENCE TO RELATED APPLICATION

The present application claims the benefit of priority from Japanese Patent Application No. 2025-061463 filed on Apr. 2, 2025. The entire disclosure of the above application is incorporated herein by reference.

### TECHNICAL FIELD

The present disclosure relates to a communication device and a communication system.

### BACKGROUND

For example, a conceivable technique teaches a communication device that includes an electrostatic discharge (ESD) protection circuit having two Zener diodes connected in reverse to each other, and a common mode choke coil for suppressing common mode noise.

### SUMMARY

According to an example, a communication device connected to a communication bus may include: a transceiver for transmitting and receiving a communication signal via the communication bus; a connection line connecting a communication bus and a transceiver; and an electrostatic discharge protection circuit disposed between the connection line and a ground potential. The electrostatic discharge protection circuit may include: a conduction element that become conductive when a voltage equal to or greater than a predetermined value is applied; and a capacitor connected in series with the conduction element.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating an example of the configuration of a communication device according to a first embodiment;

FIG. 2 is a diagram illustrating an example of the configuration of an electrostatic protection circuit of a communication device according to a first modification;

FIG. 3 is a diagram illustrating an example of the configuration of an electrostatic protection circuit of a communication device according to a second modification;

FIG. 4 is a diagram showing another example of the configuration of the electrostatic protection circuit of the communication device according to the second modification;

FIG. 5 is a diagram showing an example of the configuration of an electrostatic protection circuit of a communication device according to a third modification;

FIG. 6 is a diagram illustrating an example of the configuration of a communication device according to a fourth modification; and

FIG. 7 is a diagram showing another example of the configuration of the electrostatic protection circuit of the communication device according to the fourth modification.

### DETAILED DESCRIPTION

In recent years, a wide variety of electric drive devices and numerous electronic control devices are mounted on a vehicle for purposes such as advanced driver assistance systems (ADAS), smart entry, infotainment, anti-theft, and communication with external servers. Thus, the current consumption in the vehicle may increase. In order to cope with this increase in the current consumption, it is conceivable to increase the voltage of the battery mounted on the vehicle (for example, from 12 V to 48 V).

In addition, the numerous electronic control devices in the vehicle have communication devices for communicating with each other via an in-vehicle LAN (Local Area Network) in order to share control data and detection data and perform cooperative control.

When a communication device is equipped with an ESD protection circuit as described in the conceivable technqiue, if an anomaly occurs, for example, in which the communication line of an in-vehicle LAN is short-circuited to the power line of the vehicle, the power supply voltage generated by the battery of the vehicle may be applied to the ESD protection circuit. In this case, if a voltage that greatly exceeds the breakdown voltage of the Zener diode is applied to the ESD protection circuit due to the increase in the battery voltage, the ESD protection circuit may be damaged.

In order to protect the ESD protection circuit when a short circuit occurs between the communication line of the in-vehicle LAN and the power supply line of the vehicle, for example, it is conceivable to increase the breakdown voltage of the Zener diode of the ESD protection circuit. Here, if the breakdown voltage of a Zener diode is increased, the amount of heat generation may increase when the same amount of static electricity is applied. Therefore, in order to prevent the breakdown due to the heat generation, it becomes necessary to use a Zener diode with a large allowable loss.

However, a Zener diode with a large allowable loss also has a large stray capacitance, so that the distortion of the waveform of a communication signal may increase. Therefore, there is a risk that the ESD protection circuit will prevent high-speed communication. This difficulty can also occur when the ESD protection circuit is configured using a varistor.

The present embodiments have been made in consideration of the above-mentioned points, and aims to provide a communication device and a communication system equipped with an electrostatic discharge protection circuit that can prevent interference with high-speed communication.

In order to achieve the above object, a communication device according to the present embodiments includes: a communication device connected to a communication bus; a transceiver for transmitting and receiving a communication signal via a communication bus; a connection line connecting a communication bus and a transceiver; and an electrostatic discharge protection circuit disposed between the connection line and a ground potential. The electrostatic discharge protection circuit includes: a conduction element that become conductive when a voltage equal to or greater than a predetermined value is applied; and a capacitor connected in series with the conduction element.

In the communication device according to the present embodiments, when an anomaly occurs in which the communication bus is short-circuited to a high voltage line, the conduction element becomes conductive when the high voltage reaches or exceeds a predetermined value. Then, the capacitor is charged via the conduction element that is now in a conductive state. If the high voltage is a direct current (DC) voltage, then as the capacitor reaches a full charge state, almost no current flows through the conduction element, or even if a current flows, only a small amount of current flows. Therefore, the electrostatic discharge protection circuit can be protected without excessively increasing the voltage at which the conduction element becomes conductive. As a result, the electrostatic discharge protection circuit can be prevented from interfering with high-speed communication.

When electrostatic discharge occurs, the electrostatic discharge is an alternating current (AC) component and therefore passes through the capacitor. Therefore, the capacitor does not adversely affect the protection against electrostatic discharge.

In addition, the communication system according to the present embodiments includes: a plurality of communication devices according to the above described; and a communication bus connected to a plurality of communication devices.

This makes it possible to perform high-speed communication between a plurality of communication devices in a communication system while protecting each communication device against electrostatic discharge.

The reference signs and/or numerals in parentheses are merely added to indicate examples of correspondence relationships with concrete structures in the below-described embodiments in order to facilitate the understanding of the present disclosure, which has no intention to limit the scope of the present disclosure in any manner.

Technical features other than the above-mentioned features become apparent from the description of the embodiments and the accompanying drawings.

Hereinafter, features of a communication device and a communication system according to the present embodiments will be described with reference to the drawings. The present disclosure is not limited to the following embodiments, and various modified examples described below are also included in the technical scope of the present disclosure. In addition to the following embodiments, various modifications can be made without departing from the spirit and scope of the present embodiments. The embodiments and various modifications can be combined to extent that does not cause technical inconsistency. In the following description, the same or similar components may be denoted by the same or similar reference symbols throughout the drawings, and descriptions thereof may be omitted. In addition, in a case where only a part of the configuration is referred to in an embodiment or modification example, the description in the foregoing embodiment may be applied to the remaining configuration.

### First Embodiment

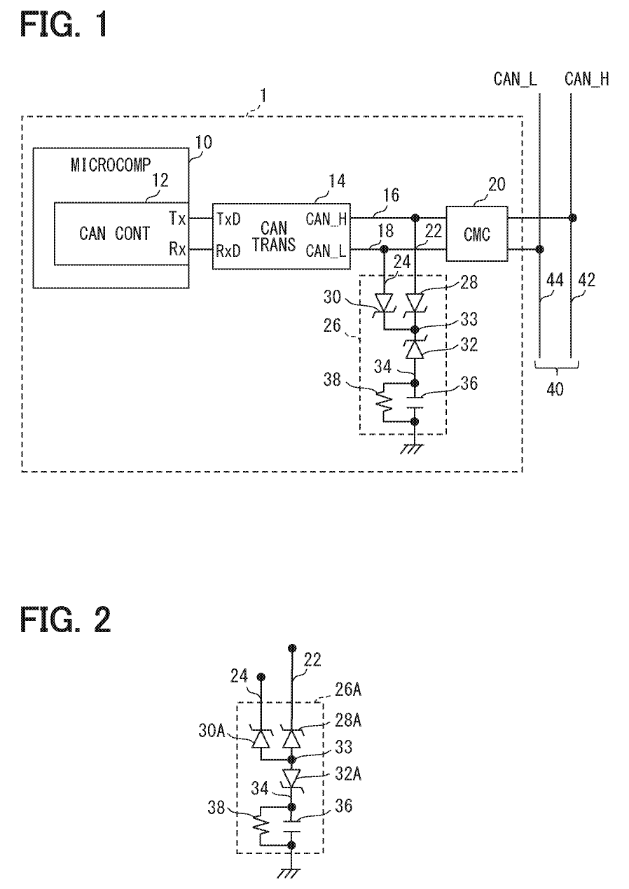

FIG. 1 is a diagram showing an example of the configuration of a communication device 1 according to the embodiment. The communication system is configured by connecting a plurality of communication devices 1 having the configuration shown in FIG. 1 to a communication bus 40. This allows the plurality of communication devices 1 in the communication system to communicate with each other via the communication bus 40.

The communication system can be used, for example, to enable various electronic control units (hereinafter referred to as in-vehicle ECUs) mounted on a vehicle to communicate with each other.

That is, the communication system can be configured so that a plurality of in-vehicle ECUs can communicate with each other via a local area network established within the vehicle, which is configured by the communication bus 40. The vehicle includes a passenger car, a motorcycle, a transportation vehicle, a construction vehicle, an agricultural vehicle, and the like. The communication system may be applied to applications other than vehicle applications.

Various communication protocols can be used for the communication in the communication system, such as CAN (Controller Area Network, registered trademark), CAN-FD (CAN with Flexible Data Rate, registered trademark), Ethernet (registered trademark), LIN (Local Interconnect Network), and FlexRAY (registered trademark). In the following description, the terms CAN, CAN-FD, Ethernet, FlexRAY, and the like will not be referred to as registered trademarks. In the following, an example will be described in which CAN is used as the communication protocol.

The communication device 1 is one of the above-mentioned in-vehicle ECUs. The communication device 1 communicates with other in-vehicle ECUs (i.e., other communication devices) via a communication bus (i.e., CAN bus) 40, such as a body ECU, an engine ECU, a motor ECU, a transmission ECU, a brake ECU, a navigation ECU, and an autonomous driving ECU, a sensor ECU for detecting sensor signals, and a drive ECU for driving actuators. When the CAN is used as the communication protocol, the communication between in-vehicle ECUs is performed in units of communication frames in the CAN protocol.

In the CAN, a two-wire communication line such as a twisted pair wire is used as the communication bus 40. Termination resistors (not shown) are connected to both ends of the two-wire communication line. A signal whose voltage level changes within a high-potential voltage range (for example, between 2.5 V and 3.5 V) is transmitted on the high-potential side line (i.e., CAN_H) 42 of the two-wire communication line. On the other hand, a signal whose voltage level changes within a low-potential voltage range (for example, between 1.5 V and 2.5 V) is transmitted on the low-potential side line (i.e., CAN_L) 44 of the two-wire communication line.

The signal on the high potential side line 42 and the signal on the low potential side line 44 are signals whose voltage levels are inverted from each other. Each communication device 1 then determines whether the state of the communication bus 40 is logic "1" (i.e., recessive) or logic "0" (i.e., dominant) based on the difference in the voltage level between the high-potential side line 42 and the low-potential side line 44 of the two-wire communication line.

More specifically, when the voltage level of the high-potential line 42 is low and the voltage level of the low-potential side line 44 is high, the potential difference is small, so the communication device 1 determines the state of the communication bus 40 to be logic "1" (i.e., recessive). On the other hand, when the voltage level of the high potential line 42 is high and the voltage level of the low potential line 44 is low, the potential difference is large, and the communication device 1 determines that the state of the communication bus 40 is logic "0" (i.e., dominant). In this way, in the CAN, the communication is performed using a two-wire differential voltage method.

As shown in FIG. 1, the communication device 1 includes a microcomputer (hereinafter referred to as MCU) 10, a CAN transceiver 14, a common mode choke coil 20, and an electrostatic discharge (ESD) protection circuit 26.

As shown in FIG. 1, the microcomputer 10 includes a built-in CAN controller 12 that controls the communication with other communication devices in accordance with the CAN protocol. In addition, the microcontroller 10 includes a processor such as a CPU (Central Processing Unit) or an MPU (Micro Processing Unit), a memory such as a RAM (Random Access Memory), and a non-volatile storage medium such as a flash memory or an SSD (Solid State Drive), all of which are not shown.

The processor is a calculation processing unit. The processor may be realized by combining multiple calculation units. When the microcomputer 10 is activated, the processor reads out a program or the like stored in a nonvolatile storage medium and executes predetermined calculation process based on the program. The microcomputer 10 is activated when the power is turned on.

The memory is a volatile memory. The memory temporarily stores programs and data required for the processor to perform the calculation process. The nonvolatile storage medium is a nonvolatile and rewritable memory. The non-volatile storage medium stores various programs such as a boot program for the microcomputer 10, a control program for realizing predetermined functions, and learning data.

The CAN controller 12 is for controlling the communication with other communication devices via the communication bus 40 in accordance with the CAN protocol. For example, the CAN controller 12 converts data created by the processor of the microcomputer 10 into a frame according to the CAN protocol, and transmits the frame to the communication bus 40 via the CAN transceiver 14. The CAN controller 12 also receives frames addressed to the microcomputer 10 that are transmitted from other communication devices via the CAN transceiver 14, and extracts data from the frames.

In addition, the CAN controller 12 performs arbitration control for bus priorities when frames collide on the bus, and performs detection and notification of errors that occur in relation to the transmission and reception of frames. The CAN controller 12 may be configured to operate at, for example, a TTL (Transistor-Transistor Logic) level or a CMOS (Complementary Metal Oxide Semiconductor) level.

The CAN controller 12 has, as signal input and output terminals, a transmission terminal Tx for outputting a transmission frame to be transmitted by the CAN transceiver 14 and a reception terminal Rx for inputting a reception frame from the CAN transceiver 14. The transmission terminal Tx of the CAN controller 12 is electrically connected to a frame signal input terminal TxD of the CAN transceiver 14. Furthermore, the reception terminal Rx of the CAN controller 12 is electrically connected to a frame signal output terminal RxD of the CAN transceiver 14.

The CAN transceiver 14 performs a transmission process of transmitting the transmission frame input from the CAN controller 12 to the communication bus 40. More specifically, when the CAN transceiver 14 transmits a transmission frame to the communication bus 40, two types of potential differences, i.e., large and small, are generated on the two-wire communication line of the communication bus 40 depending on the logical level of each bit that constitutes the transmission frame. In this way, the CAN transceiver 14 realizes transmission of a transmission frame by generating a potential difference corresponding to a digital signal "1" or "0" on the two-wire communication line of the communication bus 40.

The CAN transceiver 14 also performs a reception process of receiving a communication frame addressed to the communication device 1 and transmitted over the communication bus 40, and outputting the reception frame to the CAN controller 12. Specifically, the CAN transceiver 14 converts the potential difference occurring on the communication bus 40 into a digital signal and outputs the digital signal to the CAN controller 12 as a reception frame. The CAN controller 12 determines whether the communication frame is addressed to the communication device 1 based on the ID and other information included in the reception frame. If it is determined that the communication frame is addressed to the communication device 1 , the communication device 1 extracts data from the communication frame and outputs the data to the processor of the microcomputer 10.

When performing the above-mentioned transmission and reception processes, the CAN transceiver 14 can convert TTL (or CMOS) level signals handled by the CAN controller 12 into CAN level signals, or perform the reverse conversion process.

As described above, the CAN transceiver 14 has a CAN-H terminal and a CAN-L terminal so that the CAN transceiver 14 can transmit communication frames to the communication bus 40 and receive communication frames on the communication bus 40. The CAN_H terminal of the CAN transceiver 14 is connected to a high-potential line (i.e., CAN_H) 42 of the communication bus 40 via the first connection line 16. The CAN_L terminal of the CAN transceiver 14 is connected to a low-potential line (i.e., CAN_L) 44 of the communication bus 40 via the second connection line 18.

The common mode choke coil 20 is provided on the first connection line 16 and the second connection line 18 between the CAN transceiver 14 and the two-wire communication line of the communication bus 40. The common mode choke coil 20 acts as an inductor to suppress the common mode noise current that flows in the same direction through the first connection line 16 and the second connection line 18 . The common mode choke coil 20 may be omitted if no countermeasure against common mode noise current is required.

The ESD protection circuit 26 is provided to protect the communication device 1 when static electricity is discharged from a worker, for example, when the communication device 1 is being transported or when it the communication device 1 is being installed in a vehicle. The ESD protection circuit 26 is disposed between the first connection line 16 and the second connection line 18 connecting the communication bus 40 and the CAN transceiver 14 and the ground potential. When discharged static electricity attempts to enter the communication device 1 via the first connection line 16 and/or the second connection line 18, the static electricity is discharged to the ground potential, thereby protecting the CAN transceiver 14 and the microcontroller 10 of the communication device 1.

When the common mode choke coil 20 is provided, the ESD protection circuit 26 may be preferably arranged between the first connection line 16 and the second connection line 18, which are disposed between the CAN transceiver 14 and the common mode choke coil 20, and the ground potential, respectively. This prevents the flyback voltage generated by the common mode choke coil 20 from being applied to the CAN transceiver 14 or the microcontroller 10, for example, if an anomaly occurs in which one of the two-wire communication lines of the communication bus 40 is short-circuited to the ground.

To explain in more detail, if an anomaly occurs in which one of the two-wire communication lines of the communication bus 40 is short-circuited to the ground, the potential of one of the first connection line 16 and the second connection line 18 on which the common mode choke coil 20 is provided is fixed to the ground potential. In this state, when the current flowing through the other of the first connection line 16 and the second connection line 18 changes due to the transmission and reception of a communication signal, energy is stored in the common mode choke coil 20 when a large current is flowing. When the current decreases, the common mode choke coil 20 generates a flyback voltage due to the stored energy.

If the ESD protection circuit 26 is disposed between the first connection line 16 and the second connection line 18, which are disposed between the CAN transceiver 14 and the common mode choke coil 20, and the ground potential, respectively, the above-mentioned flyback voltage can be released to the ground potential via the ESD protection circuit 26. This makes it possible to protect the CAN transceiver 14 and the microcomputer 10 from the flyback voltage generated by the common mode choke coil 20.

The ESD protection circuit 26 is connected to the first wiring 22 that is connected to the first connection line 16 and the second wiring 24 that is connected to the second connection line 18, and is also connected to the ground potential. The ESD protection circuit 26 includes three Zener diodes 28, 30, and 32, a capacitor 36, and a resistor 38.

The three Zener diodes 28, 30, and 32 are conduction elements that become conductive when a voltage equal to or greater than a predetermined value (i.e., breakdown voltage or Zener voltage) is applied. The three Zener diodes 28, 30, and 32 are configured to have a Zener voltage that is greater than the voltage when a normal communication signal is transmitted and received and that is substantially the same. The Zener diode 28 is provided on the first wiring 22 with the direction from the first connection line 16 to the ground potential as the forward direction. The Zener diode 30 is provided on the second wiring 24 with the direction from the second connection line 18 to the ground potential as the forward direction.

The first wiring 22 and the second wiring 24 are connected to each other at a connection point 33 to form a single common wiring 34. The Zener diode 32 is provided on the common wiring 34 with the direction from the ground potential to the first connection line 16 and the second connection line 18 as the forward direction.

In other words, the Zener diode 28 and the Zener diode 32 are connected in reverse between the first connection line 16 and the ground potential. Furthermore, a Zener diode 30 and a Zener diode 32 are connected in reverse between the second connection line 18 and the ground potential. In this way, the Zener diode 32 is shared with the Zener diode 28 and the Zener diode 30. This allows the number of Zener diodes to be reduced. The Zener diodes 28 and 30 correspond to one of the first Zener diode or the second Zener diode of the present embodiments. The Zener diode 32 corresponds to the other of the first Zener diode and the second Zener diode of the present embodiments.

With the above-described configuration, regardless of the direction of the voltage generated by electrostatic discharge, once the voltage reaches or exceeds the Zener voltage, the Zener diodes 28 and 32, and/or the Zener diodes 30 and 32, become conductive. This allows static electricity to release to the ground potential, thereby protecting the CAN transceiver 14 and the microcomputer 10 of the communication device 1.

Here, for example, if the voltage of the battery mounted on the vehicle is high, and an anomaly occurs in which the communication bus 40 is short-circuited to the power line through which the high voltage is supplied from the battery, there is a possibility that a high DC voltage will be applied to the communication device 1 via the connection lines 16 and 18. At this time, if a voltage that greatly exceeds the Zener voltage of the Zener diodes 28, 30, and 32 is applied to the communication device 1, the Zener diodes 28, 30, and 32, that is, the ESD protection circuit 26, may be damaged.

In order to protect the ESD protection circuit 26 when a short circuit occurs between the communication bus 40 and the power supply line, for example, it is conceivable to increase the Zener voltage of the Zener diodes 28, 30, and 32 of the ESD protection circuit 26. However, increasing the Zener voltage of the Zener diodes 28, 30, and 32 may increase the amount of heat generation when the same amount of static electricity is applied. Therefore, in order to prevent breakdown due to heat generation, it becomes necessary to employ Zener diodes 28, 30, and 32 with a large allowable loss.

However, the Zener diodes 28, 30, and 32, which have a large allowable loss, may have a large stray capacitance. This increases distortion of the waveform of the communication signals transmitted and received via the first and second connection lines 16 and 18. Therefore, there is a risk that the ESD protection circuit 26 will interfere high-speed communication.

Therefore, in this embodiment, in the ESD protection circuit 26, a capacitor 36 is connected in series with the two Zener diodes (28 and 32, 30 and 32) connected in the opposite directions on the ground potential side of the two Zener diodes connected in the opposite directions. In other words, the capacitor 36 is connected to the ground potential side of the Zener diode 32 in the common wiring 34. By providing the capacitors 36 on the common wiring 34 in this way, the number of capacitors 36 can be reduced.

When an anomaly occurs in which the communication bus 40 is short-circuited to the high voltage from the battery and the high voltage is applied to the communication device 1, if the high voltage exceeds the Zener voltage, the two Zener diodes connected in reverse become conductive. Then, the capacitor 36 is charged via the two Zener diodes that are now in a conduction state. Since the high voltage from the battery is a DC voltage, when the capacitor 36 is fully charged, almost no current flows through the two Zener diodes, or even if a current flows, only a small current flows. Therefore, the ESD protection circuit 26 can be protected without excessively increasing the Zener voltages of the Zener diodes 28, 30, and 32. As a result, the ESD protection circuit 26 can be prevented from interfering with high-speed communication.

When electrostatic discharge occurs and the two Zener diodes (28 and 32, 30 and 32) connected in reverse are brought into a conduction state, the electrostatic discharge passes through the capacitor 36 because the electrostatic discharge is an AC component. Therefore, the capacitor 36 does not adversely affect protection against electrostatic discharge. Furthermore, the capacitor 36 is connected to the ground potential sides of the two Zener diodes. The Zener voltage of the two Zener diodes is set to be higher than the voltage when a normal communication signal is transmitted and received. Therefore, when normal communication signals are transmitted and received, the two Zener diodes remain in a cutoff state. Therefore, the capacitance of the capacitor 38 is prevented from affecting the waveform of the communication signal.

In the ESD protection circuit 26 according to this embodiment, a resistor 38 is connected in parallel to the capacitor 36. If a charge remains in the capacitor 36, for example, the potential of the first and second connection lines 16, 18 may change, which may affect the waveform of the communication signal. A resistor 38 is connected in parallel to the capacitor 36 to form a discharge path for the charge of the capacitor 36. The resistor 38 may preferably have a high resistance value, for example, 100 kΩ or more, so as to prevent thermal destruction when the communication bus 40 is short-circuited to a high voltage from a battery. Here, if a capacitor with current leakage is used as the capacitor 36, the resistor 38 may be omitted.

The communication system according to this embodiment includes a plurality of the above-described communication devices 1. In the communication system, a plurality of communication devices 1 are configured to be able to communicate with each other via a communication bus 40. As a result, the communication system according to this embodiment enables high-speed communication between a plurality of communication devices 1 while protecting each communication device 1 against electrostatic discharge.

### Modifications

One exemplary embodiment of the present disclosure is explained above. The present disclosure is not limited to the above-described embodiment, and can be implemented by various modifications without departing from the spirit of the present disclosure.

### First Modification

In the first embodiment described above, the Zener diode 28 is provided on the first wiring 22 with the direction from the first connection line 16 to the ground potential as the forward direction. The Zener diode 30 is provided on the second wiring 24 with the direction from the second connection line 18 to the ground potential as the forward direction. The Zener diode 32 is provided on the common wiring 34 with the direction from the ground potential to the first connection line 16 and the second connection line 18 as the forward direction.

Alternatively, the direction of each of the Zener diodes 28, 30, 32 may be reversed. That is, as shown in FIG. 2, a Zener diode 28A may be provided in the first wiring 22 with the direction from the ground potential to the first connection line 16 as the forward direction. A Zener diode 30A may be provided on the second wiring 24 with the direction from the ground potential to the second connection line 18 as the forward direction. A Zener diode 32 may be provided on the common wiring 34 with the direction from the first connection line 16 and the second connection line 18 to the ground potential as the forward direction.

### Second Modification

In the first embodiment described above, a configuration has been shown in which two Zener diodes connected in reverse are connected to each of the first connection line 16 and the second connection line 18, and the Zener diode 32 is shared by the Zener diode 28 and the Zener diode 30.

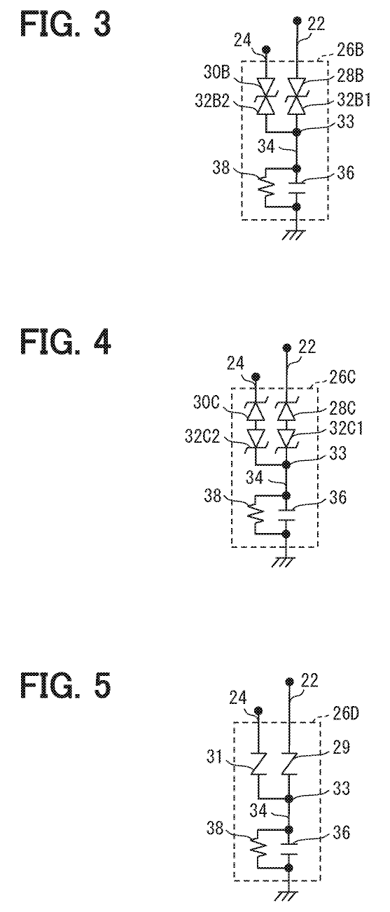

Alternatively, two Zener diodes connected in reverse may be connected to the first connecting line 16 and the second connecting line 18, respectively, without sharing the Zener diode. That is, as shown in FIG. 3, two Zener diodes 28B and 32B1 connected in reverse may be provided on the first wiring 22. Furthermore, two Zener diodes 30B and 32B2 connected in reverse may be provided on the second wiring 24.

In the configuration shown in FIG. 3, the Zener diode 28B is provided on the first wiring 22 with its forward direction being from the first connection line 16 to the ground potential, and the Zener diode 32B1 is provided on the first wiring 22 with its forward direction being from the ground potential to the first connection line 16. Furthermore, the Zener diode 30B is provided on the second wiring 24 with its forward direction being from the second connection line 18 to the ground potential, and the Zener diode 32B2 is provided on the second wiring 24 with its forward direction being from the ground potential to the second connection line 18.

Furthermore, the direction in which each Zener diode is connected may be opposite to that of the configuration shown in FIG. 3. That is, as shown in FIG. 4, the Zener diode 28C may be provided on the first wiring 22 with its forward direction being from ground potential to the first connection line 16, and the Zener diode 32C1 may be provided on the first wiring 22 with its forward direction being from the first connection line 16 to the ground potential. Alternatively, the Zener diode 30C may be provided on the second wiring 24 with its forward direction being from the ground potential to the second connection line 18, and the Zener diode 32C2 may be provided on the second wiring 24 with its forward direction being from the second connection line 18 to the ground potential.

### Third Modification

In the first embodiment, the first modification, and the second modification described above, two Zener diodes connected in reverse directions are used as the conduction elements. Alternatively, as shown in FIG. 5, varistors 29 and 30 may be used as the conduction elements. This is because the varistors 29 and 31 have the property that their resistance value decreases rapidly when a voltage equal to or greater than the varistor voltage (i.e., breakdown voltage) is applied in both directions. In the example shown in FIG. 5, a varistor 29 is provided on the first wiring 22, and a varistor 31 is provided on the second wiring 24.

### Fourth Modification

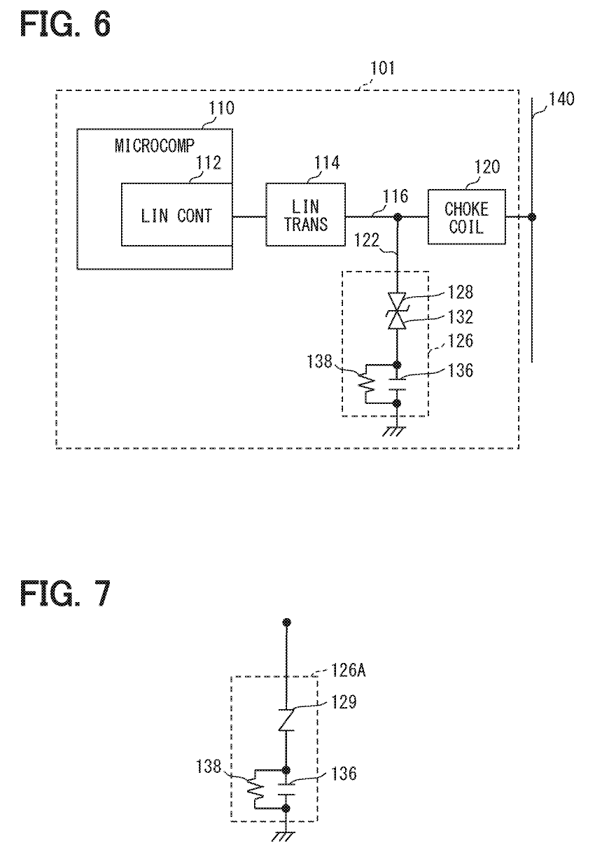

In the first embodiment described above, an example has been described in which the communication is performed in a communication system using a two-wire differential voltage method, and the communication bus 40 includes a two-wire communication line. Alternatively, the communication device 101 according to the present embodiments can also be applied to a communication system having a single-wire communication line, as shown in FIG. 6. For example, when LIN is adopted as the communication protocol, the communication device 101 performs the communication via a single-wire communication line.

In the example shown in FIG. 6, a communication bus 140, which is a single-wire communication line, and the LIN transceiver 114 are connected via a connection line 116. The connection line 116 is provided with a choke coil 120 for suppressing noise current. The LIN transceiver 114 cooperates with the LIN controller 112 provided in the microcomputer 110 to transmit and receive communication frames.

An ESD protection circuit 126 is provided between the connection line 16, which is disposed between the LIN transceiver 114 and the choke coil 120, and the ground potential. The ESD protection circuit 126 has a wiring 122 connected to the connection line. The wiring 122 is provided with two Zener diodes 128 and 132 connected in reverse directions. The direction of each of the two Zener diodes 128 and 132 may be opposite to that shown in FIG. 6. Furthermore, a capacitor 36 is connected to the wiring 122 in series with the two Zener diodes 128 and 132, which are connected in the opposite directions, on the ground potential side of the two Zener diodes 128 and 132 that are connected in the opposite directions. A resistor 138 is connected in parallel to the capacitor 136.

The communication device 101 having the above-described configuration can achieve the same functions as the communication device 1 according to the first embodiment.

The ESD protection circuit 126 shown in FIG. 6 may be replaced with an ESD protection circuit 126A shown in FIG. 7. In the ESD protection circuit 126A of FIG. 7, one varistor 129 is provided on the wiring 122 instead of the two Zener diodes 128 and 132 connected in reverse in the ESD protection circuit 126 of FIG. 6.

### Fifth Modification

In the first embodiment described above, the first connection line 16 and the second connection line 18 are connected at the connection point 33, and the common wiring 34 is provided between the connection point 33 and the ground potential. Alternatively, the first connection line 16 and the second connection line 18 may not be combined into the common wiring 34 but may be connected to the ground potential, respectively. In this case, the ESD protection circuit 126 shown in FIG. 6 and the ESD protection circuit 126A shown in FIG. 7 may be connected to the first connection line 16 and the second connection line 18, respectively.

### Technical feature

This description discloses a plurality of technical features described in a plurality of sections listed below. A feature may be described in multiple dependent form, referencing to more than one preceding features in an alternative form. Further, a feature may be written in multiple-multiple dependent form, referencing to multiple features that include a feature that is in the multiple dependent form. These features described in a multiple dependent form define multiple technical features.

### Technical feature 1

A communication device (1, 101) connected to a communication bus (40, 140) includes: a transceiver (14, 114) for transmitting and receiving a communication signal via the communication bus; a connection line (16, 18, 116) connecting the communication bus and the transceiver; and an electrostatic discharge protection circuit (26, 26A, 26B, 26C, 26D, 126, 126A) disposed between the connection line and a ground potential. The electrostatic discharge protection circuit includes: a conduction element (28, 28A, 28B, 28C, 29, 30, 30A, 30B, 30C, 31, 32, 32A, 32B1, 32B2, 32C1, 32C2, 128, 129, 132) that become conductive when a voltage equal to or greater than a predetermined value is applied; and a capacitor (36, 136) connected in series with the conduction element.

### Technical feature 2

The communication device according to Technical feature 1 further includes a resistor (38, 138) connected in parallel with the capacitor.

### Technical feature 3

In the communication device according to Technical feature 1 or 2, the capacitor is connected in series to a ground potential side of the conduction element.

### Technical feature 4

In the communication device according to any one of Technical features 1 to 3, the conduction element includes two Zener diodes (28 and 32, 30 and 32, 28A and 32A, 30A and 32A, 28B and 32B1, 30B and 32B2, 28C and 32C1, 30C and 32C2, 128 and 132) connected in reverse, or a varistor (29, 31, 129).

### Technical feature 5

In the communication device according to any one of Technical features 1 to 4, the communication bus has two communication lines (42, 44) for differential communication. The connection line has two connecting wires (16, 18) for connecting the transceiver and the two communication lines, respectively. The communication device further includes a common mode choke coil (20) provided on the two connecting wires. The electrostatic discharge protection circuit is arranged between the two connecting wires, which are disposed between the transceiver and the common mode choke coil, and the ground potential.

### Technical feature 6

In the communication device according to any one of Technical features 1 to 4, the communication bus has two communication lines (42, 44) for differential communication. The connection line has two connecting wires (16, 18) for connecting the transceiver and the two communication lines, respectively. The conduction element is respectively disposed on two wirings (22, 24) connected to the two connecting wires. The two wirings are connected to each other at a connection point (33) to form a single common wiring (34). The capacitor is disposed on the single common wiring between the connection point (33) of the single common wiring and the ground potential.

### Technical feature 7

In the communication device according to any one of Technical features 1 to 5, the communication bus has two communication lines (42, 44) for differential communication. The connection line has two connecting wires (16, 18) for connecting the transceiver and the two communication lines, respectively. The conduction element includes a first Zener diode and a second Zener diode connected in reverse. One of the first Zener diode and the second Zener diode (28, 28A, 30, 30A) is disposed on each of two wirings (22, 24) connected to the two connecting wires. The two wirings are connected to each other at a connection point (33) to form a single common wiring (34). An other of the first Zener diode and the second Zener diode (32, 32A) is disposed on the single common wiring between the connection point (33) and the ground potential. The other of the first Zener diode and the second Zener diode is shared by the one of the first Zener diode and the second Zener diode separately arranged on the two wirings. The capacitor is disposed on the single common wiring between the other of the first Zener diode and the second Zener diode and the ground potential.

### Technical feature 8

The communication device according to any one of technical features 1 to 7 is used in a vehicle for communication via a local area network established within the vehicle.

### Technical feature 9

A communication system includes: a plurality of communication devices (1) according to any one of technical features 1 to 8; and a communication bus (40, 140) connected to the plurality of communication devices.

Reference numeral 1 indicates a communication device, reference numeral 10 indicates a microcomputer, reference numeral 12 indicates a CAN controller, reference numeral 14 indicates a CAN transceiver, reference numeral 16 indicates a first connection line, reference numeral 18 indicates a second connection line, reference numeral 20 indicates a common mode choke coil, reference numeral 22 indicates a first wiring, reference numeral 24 indicates a second wiring, reference numerals 26, 26A, 26B, 26C, and 26D indicate ESD protection circuits, reference numerals 28, 28A, 28B, and 28C indicate Zener diodes, reference numeral 29 indicates a varistor, reference numerals 30, 30A, 30B, and 30C indicate Zener diodes, reference numeral 31 indicates a varistor, reference numerals 32, 32A, 32B1, 32B2, 32B3, 32C1, and 32C2 indicate Zener diodes, reference numeral 33 indicates a connection point, reference numeral 34 indicates a common wiring, reference numeral 36 indicates a capacitor, reference numeral 38 indicates a resistor, reference numeral 40 indicates a communication bus, reference numeral 101 indicates a communication device, reference numeral 110 indicates a microcomputer, reference numeral 112 indicates a LIN controller, reference numeral 114 indicates a LIN transceiver, reference numeral 116 indicates a connection line, reference numeral 120 indicates a choke coil, reference numeral 122 indicates a wiring, reference numeral 126 indicates an ESD protection circuit, reference numeral 128 indicates a Zener diode, reference numeral 129 indicates a varistor, reference numeral 132 indicates a Zener diode, reference numeral 136 indicates a capacitor, reference numeral 138 indicates a resistor, and reference numeral 140 indicates a communication bus.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A communication device connected to a communication bus comprising:
a transceiver for transmitting and receiving a communication signal via the communication bus;
a connection line connecting a communication bus and a transceiver; and
an electrostatic discharge protection circuit disposed between the connection line and a ground potential, wherein:
the electrostatic discharge protection circuit includes:
a conduction element that become conductive when a voltage equal to or greater than a predetermined value is applied; and
a capacitor connected in series with the conduction element.

2. The communication device according to claim 1, further comprising:
a resistor connected in parallel with the capacitor.

3. The communication device according to claim 1, wherein:
the capacitor is connected in series to a ground potential side of the conduction element.

4. The communication device according to claim 1, wherein:
the conduction element includes two Zener diodes connected in reverse, or a varistor.

5. The communication device according to claim 1, wherein:
the communication bus has two communication lines for differential communication; and
the connection line has two connecting wires for connecting the transceiver and the two communication lines, respectively;
the communication device further comprising:
a common mode choke coil provided on the two connecting wires, wherein:
the electrostatic discharge protection circuit is arranged between the two connecting wires, which are disposed between the transceiver and the common mode choke coil, and the ground potential.

6. The communication device according to claim 1, wherein:
the communication bus has two communication lines for differential communication;
the connection line has two connecting wires for connecting the transceiver and the two communication lines, respectively;
the conduction element is respectively disposed on two wirings connected to the two connecting wires;
the two wirings are connected to each other at a connection point to form a single common wiring; and
the capacitor is disposed on the single common wiring between the connection point of the single common wiring and the ground potential.

7. The communication device according to claim 1, wherein:
the communication bus has two communication lines for differential communication;
the connection line has two connecting wires for connecting the transceiver and the two communication lines, respectively;
the conduction element includes a first Zener diode and a second Zener diode connected in reverse;
one of the first Zener diode and the second Zener diode is disposed on each of two wirings connected to the two connecting wires;
the two wirings are connected to each other at a connection point to form a single common wiring;
an other of the first Zener diode and the second Zener diode is disposed on the single common wiring between the connection point and the ground potential;
the other of the first Zener diode and the second Zener diode is shared by the one of the first Zener diode and the second Zener diode separately arranged on the two wirings; and
the capacitor is disposed on the single common wiring between the other of the first Zener diode and the second Zener diode and the ground potential.

8. The communication device according to claim 1, wherein:
the communication device is used in a vehicle for communication via a local area network established within the vehicle.

9. A communication system comprising:
a plurality of communication devices; and
a communication bus connected to the plurality of communication devices, wherein:
each of the plurality of communication devices is connected to a communication bus;
each of the plurality of communication devices includes:
a transceiver for transmitting and receiving a communication signal via the communication bus;
a connection line connecting a communication bus and a transceiver; and
an electrostatic discharge protection circuit disposed between the connection line and a ground potential; and
the electrostatic discharge protection circuit includes:
a conduction element that become conductive when a voltage equal to or greater than a predetermined value is applied; and
a capacitor connected in series with the conduction element.
